(19) United States
(12) Patent Application Publication
(10) Pub. No.: US 2026/0365017 A1
(43) Pub. Date: Nov. 19, 2026

(54) IMAGE DISPLAY SYSTEM FOR MARINE VESSELS AND IMAGE DISPLAY METHOD FOR MARINE VESSELS

(71) Applicant: YAMAHA HATSUDOKI KABUSHIKI KAISHA, Iwata-shi (JP)

(72) Inventors: Takaaki BAMBA, Shizuoka (JP); Akihiro TAGATA, Shizuoka (JP)

(21) Appl. No.: 19/678,288

(22) Filed: May 15, 2026

(30) Foreign Application Priority Data
May 16, 2025 (JP) 2025-082845

(51) Int. Cl. B60K 35/22; B60K 35/28; B60K 35/81; G01S 7/04; G01S 13/86; G01S 13/89; G01S 13/937

(52) U.S. Cl. CPC B60K 35/22; B60K 35/28; B60K 35/81; G01S 7/04; G01S 13/865; G01S 13/89; G01S 13/937; B60K 2360/179

(57) ABSTRACT

An image display system for marine vessels that assist vessel operators to easily monitor the surroundings of the marine vessels in accordance with vessel steering situations includes a sensor to detect and acquire location data of an object by emitting electromagnetic waves around the marine vessel. A controller of the image display system is configured or programmed to cause a display to display a bird's-eye view image of the marine vessel that is generated based on the location data. The controller is configured or programmed to control the display to display the bird's-eye view image to cover a display range differentiated based on at least one of a state of the marine vessel or a state around the marine vessel.

### CROSS REFERENCE TO RELATED APPLICATIONS

This application claims the benefit of priority to Japanese Patent Application No. 2025-082845 filed on May 16, 2025. The entire contents of this application are hereby incorporated herein by reference.

### BACKGROUND OF THE INVENTION

### 1. Field of the Invention

The present invention relates to image display systems for marine vessels and image display methods for marine vessels.

### 2. Description of the Related Art

There is a known system for assisting vessel steering. In the system, for example, cameras on a marine vessel capture images of the surroundings of the marine vessel, and a display unit displays an image of the surroundings of the marine vessel created based on the captured images. Thus, a vessel operator can easily monitor the surroundings of the marine vessel (see Japanese Laid-Open Patent Publication (Kokai) No. 2020-155893, for example).

However, since the cameras only capture images in the near vicinity of the marine vessel, the above-described technique is not suitable for monitoring situations far from the marine vessel and assisting the vessel operator. To steer a marine vessel in a wide area on the sea or on a lake, a vessel operator relies on monitoring a wider area around the marine vessel, and there is still room for improvement in displaying images of the surroundings of the marine vessel.

### SUMMARY OF THE INVENTION

Example embodiments of the present invention provide image display systems for marine vessels and image display methods for marine vessels which assist vessel operators to easily monitor the surroundings of the marine vessels in accordance with vessel steering situations.

According to an example embodiment of the present invention, an image display system for a marine vessel includes a display and a sensor to detect and acquire location data of an object by emitting electromagnetic waves around the marine vessel. The image display system further includes a controller configured or programmed to cause the display to display a bird's-eye view image of the marine vessel that is generated based on the location data. The controller is configured or programmed to control the display to display the bird's-eye view image including a display range differentiated based on at least one of a state of the marine vessel or a state around the marine vessel.

According to another example embodiment of the present invention, an image display method for a marine vessel includes detecting and acquiring location data of an object by emitting electromagnetic waves around the marine vessel, and causing a display to display a bird's-eye view image of the marine vessel that is generated based on the location data. In displaying the bird's-eye view image, the display is controlled to display the bird's-eye view image including a display range differentiated based on at least one of a state of the marine vessel or a state around the marine vessel.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view of an example of a marine vessel including an image display system.

FIG. 2 is a perspective view of relevant portions of a cockpit of the marine vessel illustrated in FIG. 1.

FIG. 3 is a block diagram schematically illustrating an example configuration of a vessel steering system included in the marine vessel illustrated in FIG. 1.

FIG. 4 is a diagram illustrating an example of a bird's-eye view image to be displayed on a multi-function display (MFD) illustrated in FIG. 2.

FIG. 5 is a flowchart illustrating a procedure of an example of a bird's-eye view display control process to be executed by the vessel steering system illustrated in FIG. 3.

FIG. 6A and FIG. 6B are diagrams for explaining an enlarged bird's-eye view image to be displayed in step S52 in FIG. 5.

FIG. 7A and FIG. 7B are diagrams for explaining a bird's-eye view image to be displayed in step S58 in FIG. 5.

FIG. 8A and FIG. 8B are diagrams for explaining a reference bird's-eye view image to be displayed in step S59 in FIG. 5.

FIG. 9A and FIG. 9B are diagrams for explaining a bird's-eye view image to be displayed in step S62 in FIG. 5.

FIG. 10A and FIG. 10B are diagrams for explaining a bird's-eye view image to be displayed in step S63 in FIG. 5.

FIG. 11 is a diagram for explaining a modification of the display range of a bird's-eye view image to be displayed on the MFD illustrated in FIG. 2.

### DETAILED DESCRIPTION OF THE EXAMPLE EMBODIMENTS

Hereinafter, example embodiments of the present invention will be described with reference to the drawings.

With an image display system for marine vessels and an image display method for marine vessels according to an example embodiment, a display indicates a bird's-eye view image that is generated based on location data acquired by a sensor and covers a display range appropriate for the state of the marine vessel and/or the state of the surroundings of the marine vessel. Thus, it is possible to assist a vessel operator to easily monitor the surroundings of the marine vessel in accordance with the vessel steering situation.

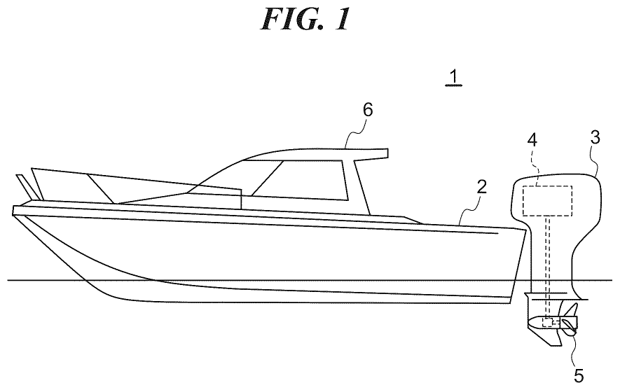

FIG. 1 is a side view of an example of a marine vessel including an image display system according to an example embodiment of the present invention. A marine vessel 1 includes a hull 2 and two outboard motors 3 attached to the hull 2. Each of the outboard motors 3 includes an engine 4 and a propeller 5, and generates a thrust force by the propeller 5 rotated by a drive force of the engine 4. Note that the number of the outboard motors 3 on the marine vessel 1 is not necessarily two. Instead, the marine vessel 1 may include only one outboard motor 3, or the marine vessel 1 may include three or more outboard motors 3. Alternatively, the marine vessel 1 may include an electric outboard motor, an inboard motor, or an inboard/outboard motor as a marine propulsion device in place of the outboard motors 3. Further, the marine vessel 1 may be a jet propulsion boat.

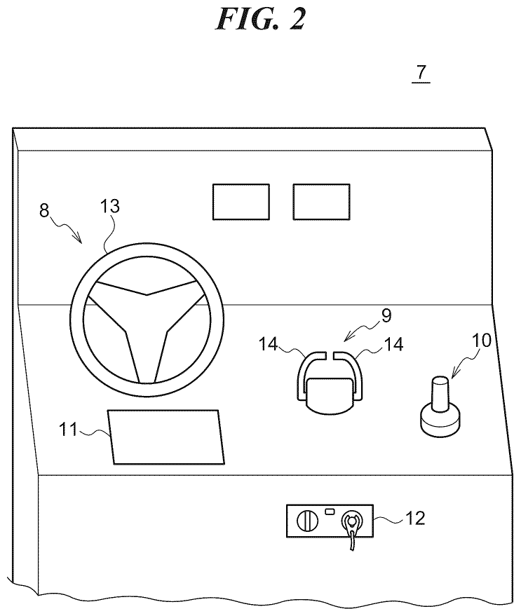

In the marine vessel 1, the hull 2 houses a cabin 6, and a cockpit 7 is disposed in the cabin 6. FIG. 2 is a perspective view of relevant portions of the cockpit 7. A steering mechanism 8, a remote controller 9, a joystick 10, a multi-functional display (MFD) 11, and a main switch 12 are disposed in the cockpit 7.

The steering mechanism 8 is a device for a vessel operator to determine the course of the marine vessel 1. The steering mechanism 8 includes a turnable steering wheel 13. When a vessel operator turns the steering wheel 13 left or right, this controls the motor steering mechanisms of the outboard motors 3, each including an actuator and a bracket, to change the orientations of the outboard motors 3.

The remote controller 9 includes two levers 14 corresponding to the respective outboard motors 3. A vessel operator operating one of the levers 14 is able to switch the direction in which a thrust force generated by the corresponding outboard motor 3 acts between forward and backward, and to control the output of the corresponding outboard motor 3 to adjust the velocity of the marine vessel 1. For example, when a vessel operator moves one of the levers 14 forward, that is, to a forward position to advance the marine vessel 1, the corresponding outboard motor 3 generates a thrust force in the forward direction. When a vessel operator moves one of the levers 14 backward, that is, to a reverse position to move the marine vessel 1 backward, the corresponding outboard motor 3 generates a thrust force in the backward direction. Further, when a vessel operator moves one of the levers 14 to a neutral position located between the forward position and the reverse position, the connection between the engine 4 and the propeller 5 is disconnected by a clutch in the corresponding outboard motor 3, and the corresponding outboard motor 3 does not apply a thrust force to the marine vessel 1.

The joystick 10 (a specific example of an operating mechanism) is a rod-shaped operating component that is tiltable forward, backward, leftward, and rightward and pivotable about an axis. A vessel operator operating the joystick 10 is able to move the marine vessel 1 along a course corresponding to the tilting direction of the joystick 10 with a thrust force corresponding to the amount of tilt of the joystick 10. When the joystick 10 is operated, the marine vessel 1 moves at a low velocity. For example, a vessel operator uses the joystick 10 for docking or undocking the marine vessel 1.

The MFD 11 (a display or display unit) includes, for example, a color LCD display, and functions as a display to display various types of information. The MFD 11 displays, for example, a bird's-eye view image presenting a state around the marine vessel 1, which will be described below. The MFD 11 also functions as a touch panel to receive an input from a vessel operator.

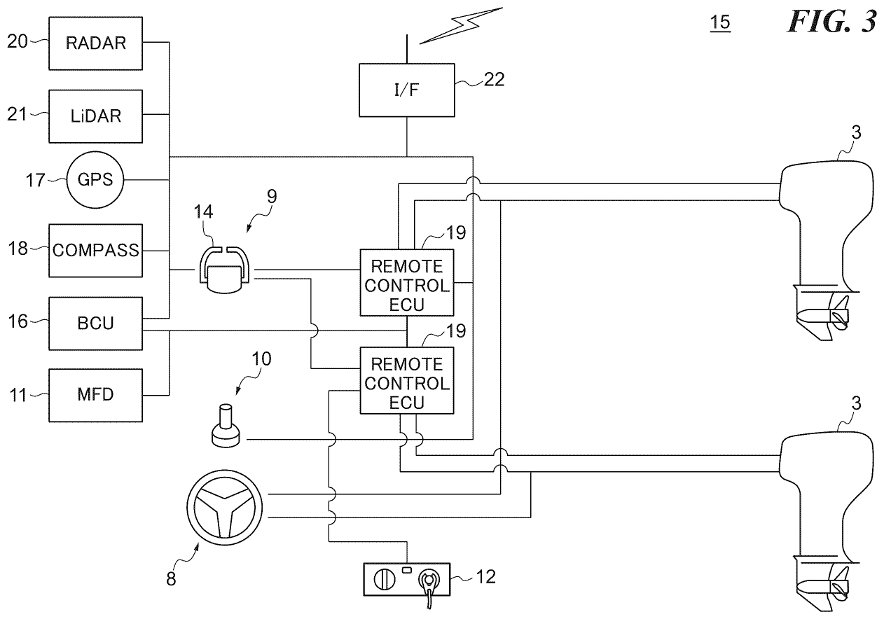

FIG. 3 is a block diagram schematically illustrating an example configuration of a vessel steering system 15 included in the marine vessel 1 illustrated in FIG. 1. In FIG. 3, the vessel steering system 15 includes the outboard motors 3, the steering mechanism 8, the remote controller 9, the joystick 10, the MFD 11, the main switch 12, a boat control unit (BCU) 16 (a controller), a GPS 17, a compass 18, remote control engine control units (remote control ECUs) 19, a radar (RADAR) 20, a lidar (LiDAR) 21, and a communication interface (I/F) 22. The components of the vessel steering system 15 are communicably connected to one another. In the present example embodiment, the vessel steering system 15 also serves as an image display system.

The steering mechanism 8 is configured to transmit, to the remote control ECUs 19, steering angle signals corresponding to a turning operation performed on the steering wheel 13 by a vessel operator. The remote controller 9 is configured to transmit, to the remote control ECUs 19, signals (e.g., forward or reverse movement signals) corresponding to operations performed on the levers 14 by a vessel operator. The joystick 10 is configured to transmit, to the remote control ECUs 19, signals corresponding to the direction of tilt and the amount of tilt resulting from an operation performed on the joystick 10 by a vessel operator. The MFD 11 is configured to transmit, to the BCU 16 and the remote control ECUs 19, signals corresponding to an input received via the MFD 11 from a vessel operator.

The main switch 12 is configured to receive an instruction to turn on or start the outboard motors 3, and then transmit signals corresponding to the received instruction to the BCU 16 and the remote control ECUs 19. The BCU 16 is configured to monitor situations of the marine vessel 1 based on signals transmitted from the components of the vessel steering system 15, determine the magnitudes of the thrust forces to be generated by the outboard motors 3 and the acting directions in which the thrust forces are to be directed, and then transmit control signals to the remote control ECUs 19.

The GPS 17 is configured to monitor the current location of the marine vessel 1, and transmit to the BCU 16 the current location of the marine vessel 1 as location information. The compass 18 is configured to monitor the heading of the marine vessel 1 (the direction in which the bow of the marine vessel 1 is pointed), and transmit the heading of the marine vessel 1 to the BCU 16. The radar 20 is configured to detect and acquire location data of an object by emitting electromagnetic waves, specifically radio waves, around the marine vessel 1. The radar 20 has a wider object detection range than the lidar 21, and can operate relatively stably even under bad weather conditions such as rain or fog. The lidar 21 is configured to detect and acquire location data of an object by emitting electromagnetic waves, specifically laser light, around the marine vessel 1. The lidar 21 can perform highly accurate 3D mapping, and has a high ability to recognize an object. The radar 20 and the lidar 21 are configured to transmit the acquired object location data to the BCU 16.

The communication I/F 22 is configured to communicate with external servers and other devices outside the marine vessel 1, and transmit signals received from external sources to the BCU 16. For example, the communication I/F 22 uses an automatic identification system (AIS) to acquire information about the locations, courses, and velocities of other marine vessels. Note that the AIS is a system that transmits and receives information about the locations, courses, and velocities of marine vessels by VHF radio waves, and exchanges information between marine vessels or between marine vessels and onshore facilities.

For each of the outboard motors 3, one remote control ECU 19 is provided. According to signals transmitted from the BCU 16, the remote controller 9, the joystick 10, or the like, each of the remote control ECUs 19 controls actuators for the motor steering mechanism and the shift mechanism of the corresponding outboard motor 3 and for the throttle mechanism of the engine 4 of the corresponding outboard motor 3, thus adjusting the magnitude of a thrust force to be generated by the corresponding outboard motor 3 and the direction in which the thrust force acts. Therefore, with the vessel steering system 15, a vessel operator can control the velocity and the direction of the bow of the marine vessel 1 by operating the joystick 10 or the levers 14 of the remote controller 9. Note that the shift mechanism includes a clutch, a shift fork, and a gear, and is configured to switch the direction of the thrust force between forward and backward by changing the direction of rotation of the propeller 5. The throttle mechanism of the engine 4 is configured to adjust the amount of intake air of the engine 4 to control the speed of the engine 4, thus controlling the magnitude of the thrust force.

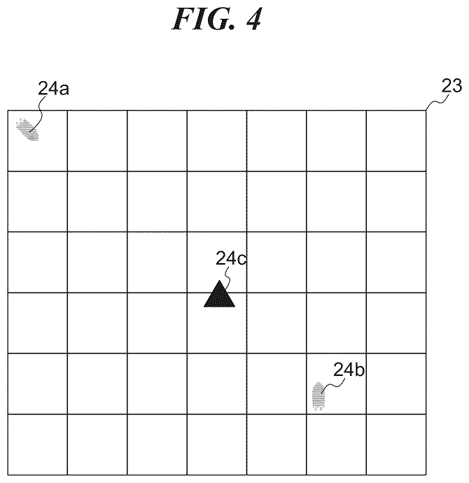

The vessel steering system 15 includes vessel steering modes including a manual vessel steering mode and an automatic vessel steering mode. In the automatic vessel steering mode, the BCU 16 controls the actuators of the motor steering mechanism, the shift mechanism, and the throttle mechanism of the engine 4 of each of the outboard motors 3, to navigate the marine vessel 1, without referring to input operations performed by a vessel operator. In the manual vessel steering mode, on the other hand, a vessel operator controls the velocity of the marine vessel 1 and the direction of the bow by operating the joystick 10 or the levers 14 of the remote controller 9 while checking a bird's-eye view image 23 displayed on the MFD 11 as illustrated in FIG. 4.

FIG. 4 is a diagram illustrating an example of the bird's-eye view image 23 to be displayed on the MFD 11 illustrated in FIG. 2. The bird's-eye view image 23 is generated based on location data indicating the locations of objects detected by the lidar 21. In the bird's-eye view image 23, a region 24a and a region 24b indicate objects detected by the lidar 21, and a region 24c indicates the marine vessel 1. A vessel operator can monitor the surroundings of the marine vessel 1 by checking the bird's-eye view image 23. Note that the range a vessel operator wishes to check in the bird's-eye view image 23 varies depending on the vessel steering situation, and therefore, the vessel steering system 15 is configured to control changing the display range of the bird's-eye view image 23 appropriately. Specifically, in the present example embodiment, the MFD 11 is caused to display a bird's-eye view image including a display range differentiated based on at least one of (in other words, one or more of) the state of the marine vessel 1 and the state around the marine vessel 1.

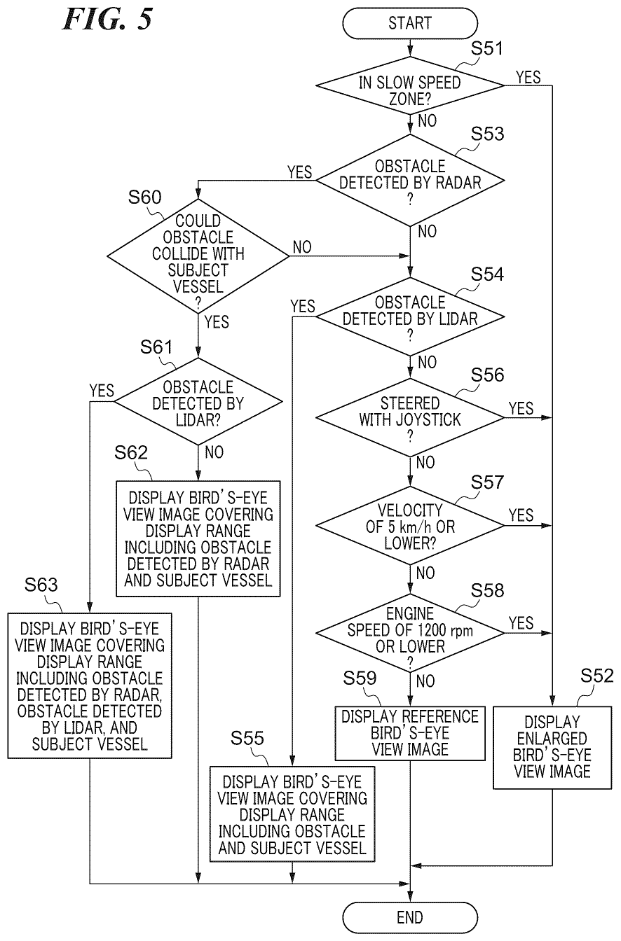

FIG. 5 is a flowchart illustrating the procedure of an example of a bird's-eye view display control process to be executed by the vessel steering system 15 illustrated in FIG. 3. This process is executed by the BCU 16 in accordance with a program stored in a memory or a program temporarily downloaded from an external server. Note that this process is repeatedly performed, for example, while the vessel steering system 15 is running.

In FIG. 5, the BCU 16 first determines whether the marine vessel 1 is located in a predetermined slow speed zone (step S51). In step S51, the BCU 16 uses, for example, location information about the marine vessel 1 as acquired by the GPS 17 or the like, to determine whether the marine vessel 1 is located in a slow speed zone. A slow speed zone is a zone in which the velocity of a traveling marine vessel is designated to be a certain velocity or lower. In a slow speed zone, other marine vessels also travel at reduced speeds, and marine vessels may pass each other at a relatively close distance. Therefore, when the marine vessel 1 is located in a slow speed zone, it is preferable to display a bird's-eye view image including a display range that allows a vessel operator to observe the vicinity of the marine vessel 1.

In a case where it is determined in step S51 that the marine vessel 1 is located in the slow speed zone, the process proceeds to step S52.

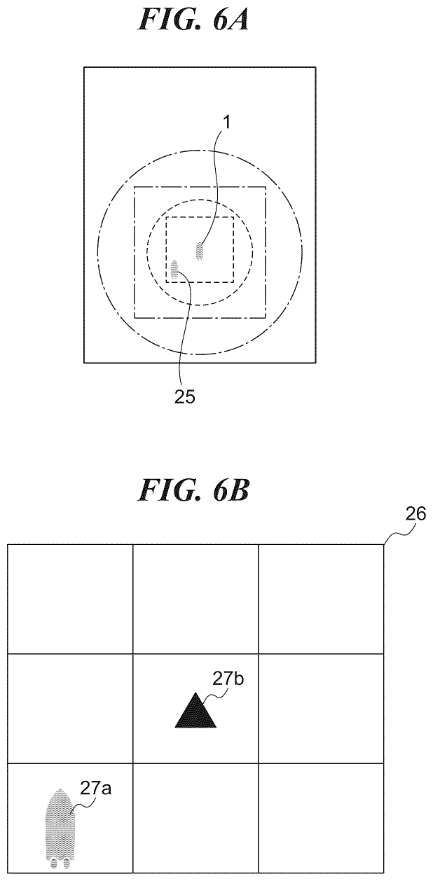

In step S52, the BCU 16 causes the MFD 11 to display an enlarged bird's-eye view image, which is created by enlarging a reference bird's-eye view image at a predetermined enlargement factor (e.g., at a 3× enlargement factor). The reference bird's-eye view image is a bird's-eye view image including a display range that is centered on the marine vessel 1 and is capable of presenting the entire detection range of the lidar 21. The enlarged bird's-eye view image to be displayed in step S52 is now described with reference to FIGS. 6A and 6B.

FIG. 6A is a diagram for explaining the display range of the enlarged bird's-eye view image to be displayed in step S52. In FIG. 6A, the region indicated by a dotted circle indicates the detection range of the lidar 21, the region indicated by a dot-and-dash circle indicates the detection range of the radar 20, the region indicated by a dotted quadrangle indicates the display range of the enlarged bird's-eye view image to be displayed on the MFD 11 in step S52, and the region indicated by a dot-and-dash quadrangle indicates the display range of the reference bird's-eye view image. In a case where the marine vessel 1 and a marine vessel 25 detected by the lidar 21 have the positional relationship as illustrated in FIG. 6A, an enlarged bird's-eye view image 26 illustrated in FIG. 6B is displayed on the MFD 11 in step S52. In this case, the enlarged bird's-eye view image 26 includes a region 27a of the marine vessel 25 detected by the lidar 21, and a region 27b of the marine vessel 1. When the processing in step S52 is completed, this process comes to an end.

In a case where it is determined in step S51 that the marine vessel 1 is not located in the slow speed zone, the process proceeds to step S53. In step S53, the BCU 16 determines whether an obstacle is detected by the radar 20 having a wider detection range than the lidar 21.

In a case where it is determined in step S53 that no obstacle is detected by the radar 20, the process proceeds to step S54. In step S54, the BCU 16 determines whether an obstacle is detected by the lidar 21.

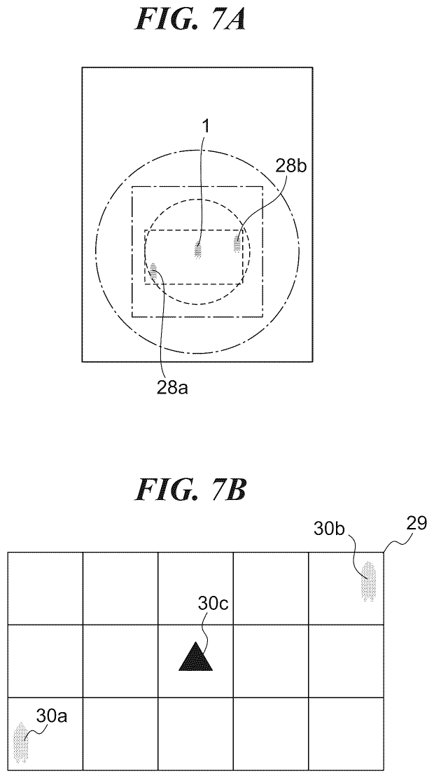

In a case where it is determined in step S54 that an obstacle is detected by the lidar 21, the process proceeds to step S55. In step S55, the BCU 16 causes the MFD 11 to display a bird's-eye view image including a display range including the obstacle detected by the lidar 21 and the marine vessel 1. The bird's-eye view image to be displayed in step S55 is now described with reference to FIGS. 7A and 7B.

FIG. 7A is a diagram for explaining the display range of the bird's-eye view image to be displayed in step S55. In FIG. 7A, the region indicated by a dotted circle indicates the detection range of the lidar 21, the region indicated by a dot-and-dash circle indicates the detection range of the radar 20, the region indicated by a dotted quadrangle indicates the display range of the bird's-eye view image to be displayed on the MFD 11 in step S55, and the region indicated by a dot-and-dash quadrangle indicates the display range of the reference bird's-eye view image. Here, it is assumed that a marine vessel 28a and a marine vessel 28b are detected as obstacles by the lidar 21.

In a case where the marine vessel 1 and the marine vessel 28a and the marine vessel 28b detected by the lidar 21 have the positional relationship as illustrated in FIG. 7A, a bird's-eye view image 29 illustrated in FIG. 7B is displayed on the MFD 11 in step S55. The bird's-eye view image 29 includes a region 30a and a region 30b respectively corresponding to the marine vessel 28a and the marine vessel 28b detected by the lidar 21, and a region 30c of the marine vessel 1. In the bird's-eye view image 29, the region 30a corresponding to the marine vessel 28a is located at the lower left corner, and the region 30b corresponding to the marine vessel 28b is located at the upper right corner. When the processing in step S55 is completed, this process comes to an end.

In a case where it is determined in step S54 that no obstacle is detected by the lidar 21, the process proceeds to step S56. In step S56, the BCU 16 determines whether the marine vessel 1 is being steered with the joystick 10. In a case where the joystick 10 is being operated, the marine vessel 1 moves at a low velocity as in the case where the marine vessel 1 is located in a slow speed zone. Therefore, from the viewpoint of visibility for a vessel operator at a time of the low-velocity movement, a bird's-eye view image covering the same display range as that in the case where the marine vessel 1 is located in a slow speed zone is preferably displayed.

In a case where it is determined in step S56 that the marine vessel 1 is being steered with the joystick 10, the process proceeds to step S52, and an enlarged bird's-eye view image obtained by enlarging the reference bird's-eye view image at a predetermined enlargement factor (e.g., at a 3× enlargement factor) is displayed on the MFD 11. After that, this process comes to an end.

In a case where it is determined in step S56 that the marine vessel 1 is not being steered with the joystick 10, the process proceeds to step S57. In step S57, the BCU 16 determines whether the velocity of the marine vessel 1 is a predetermined velocity (e.g., 5 km/h) or lower. In a case where the velocity of the marine vessel 1 is the predetermined velocity (e.g., 5 km/h) or lower, the marine vessel 1 moves at a low velocity as in the case where the marine vessel 1 is located in a slow speed zone. Therefore, from the viewpoint of visibility for a vessel operator at a time of the low-velocity movement, a bird's-eye view image covering the same display range as that in the case where the marine vessel 1 is located in a slow speed zone is preferably displayed.

In a case where it is determined in step S57 that the velocity of the marine vessel 1 is the predetermined velocity (e.g., 5 km/h) or lower, the process proceeds to step S52, and an enlarged bird's-eye view image obtained by enlarging the reference bird's-eye view image at a predetermined enlargement factor (e.g., at a 3× enlargement factor) is displayed on the MFD 11. In this case, in step S52, the lower the velocity of the marine vessel is, the greater the enlargement factor may be. After that, this process comes to an end.

In a case where it is determined in step S57 that the velocity of the marine vessel 1 is not the predetermined velocity (e.g., 5 km/h) or lower, the process proceeds to step S58. In step S58, the BCU 16 determines whether the speed of the engine 4 of the marine vessel 1 is a predetermined speed (e.g., 1200 rpm) or lower. In a case where the speed of the engine 4 of the marine vessel 1 is the predetermined speed (e.g., 1200 rpm) or lower, the marine vessel 1 moves at a low velocity as in the case where the marine vessel 1 is located in a slow speed zone. Therefore, from the viewpoint of visibility for a vessel operator at a time of the low-velocity movement, a bird's-eye view image covering the same display range as that in the case where the marine vessel 1 is located in a slow speed zone is preferably displayed.

In a case where it is determined in step S58 that the speed of the engine 4 of the marine vessel 1 is the predetermined speed (e.g., 1200 rpm) or lower, the process proceeds to step S52, and an enlarged bird's-eye view image obtained by enlarging the reference bird's-eye view image at a predetermined enlargement factor (e.g., at a 3× enlargement factor) is displayed on the MFD 11. In this case, in step S52, the lower the speed of the engine 4 of the marine vessel 1 is, the greater the enlargement factor may be. After that, this process comes to an end.

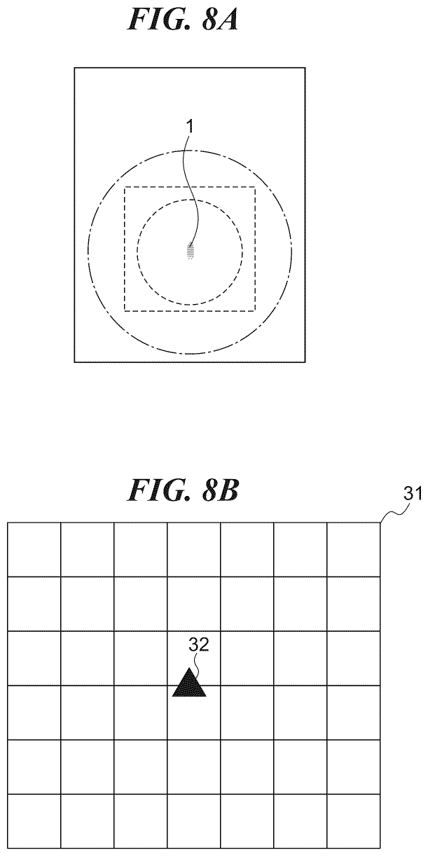

In a case where it is determined in step S58 that the speed of the engine 4 of the marine vessel 1 is not the predetermined speed (e.g., 1200 rpm) or lower, the process proceeds to step S59. In step S59, the BCU 16 causes the MFD 11 to display the reference bird's-eye view image. The reference bird's-eye view image to be displayed in step S59 is now described with reference to FIGS. 8A and 8B.

FIG. 8A is a diagram for explaining the display range of the reference bird's-eye view image to be displayed in step S59. In FIG. 8A, the region indicated by a dotted circle indicates the detection range of the lidar 21, the region indicated by a dot-and-dash circle indicates the detection range of the radar 20, and the region indicated by a dotted quadrangle indicates the display range of the bird's-eye view image to be displayed on the MFD 11 in step S59, which is the display range of the reference bird's-eye view image. In step S59, a reference bird's-eye view image 31 illustrated in FIG. 8B is displayed on the MFD 11. The reference bird's-eye view image 31 includes only a region 32 of the marine vessel 1. When the processing in step S59 is completed, this process comes to an end.

In a case where it is determined in step S53 that an obstacle is detected by the radar 20, the process proceeds to step S60. In step S60, the BCU 16 determines whether there is a possibility that the obstacle detected by the radar 20 will collide with the marine vessel 1. In step S60, for example, in a case where the obstacle is not located in the traveling direction of the marine vessel 1, and in a case where the obstacle is not moving toward the marine vessel 1, it is determined that there is not a possibility that the obstacle will collide with the marine vessel 1. In this case, the process proceeds to step S54. Note that, for example, in a case where the obstacle is another marine vessel, the determination as to whether the obstacle is moving toward the marine vessel 1 is made by the BCU 16 based on the traveling direction of the other marine vessel identified from information acquired from the other marine vessel via the AIS.

In a case where the obstacle is located in the traveling direction of the marine vessel 1, or in a case where the obstacle is moving toward the marine vessel 1, it is determined in step S60 that there is a possibility that the obstacle will collide with the marine vessel 1. In this case, the process proceeds to step S61. In step S61, the BCU 16 determines whether an obstacle is detected by the lidar 21 in addition to the detection by the radar 20.

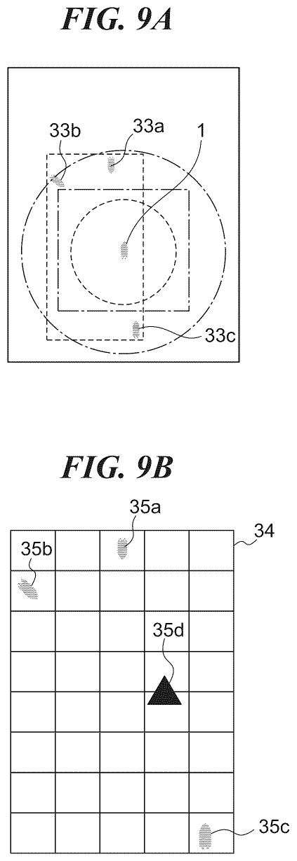

In a case where it is determined in step S61 that no obstacle is detected by the lidar 21, the process proceeds to step S62. In step S62, the BCU 16 causes the MFD 11 to display a bird's-eye view image including a display range including the obstacle detected by the radar 20 and the marine vessel 1. The bird's-eye view image to be displayed in step S62 is now described with reference to FIGS. 9A and 9B.

FIG. 9A is a diagram for explaining the display range of the bird's-eye view image to be displayed in step S62. In FIG. 9A, the region indicated by a dotted circle indicates the detection range of the lidar 21, the region indicated by a dot-and-dash circle indicates the detection range of the radar 20, the region indicated by a dotted quadrangle indicates the display range of the bird's-eye view image to be displayed on the MFD 11 in step S62, and the region indicated by a dot-and-dash quadrangle indicates the display range of the reference bird's-eye view image. Here, it is assumed that a marine vessel 33a, a marine vessel 33b, and a marine vessel 33c are detected as obstacles by the radar 20. In a case where the marine vessel 1, the marine vessel 33a, the marine vessel 33b, and the marine vessel 33c detected by the radar 20 have the positional relationship as illustrated in FIG. 9A, a bird's-eye view image 34 illustrated in FIG. 9B is displayed on the MFD 11 in step S62. The bird's-eye view image 34 includes a region 35a, a region 35b, and a region 35c respectively corresponding to the marine vessel 33a, the marine vessel 33b, and the marine vessel 33c detected by the radar 20, and a region 35d of the marine vessel 1. When the processing in step S62 is completed, this process comes to an end.

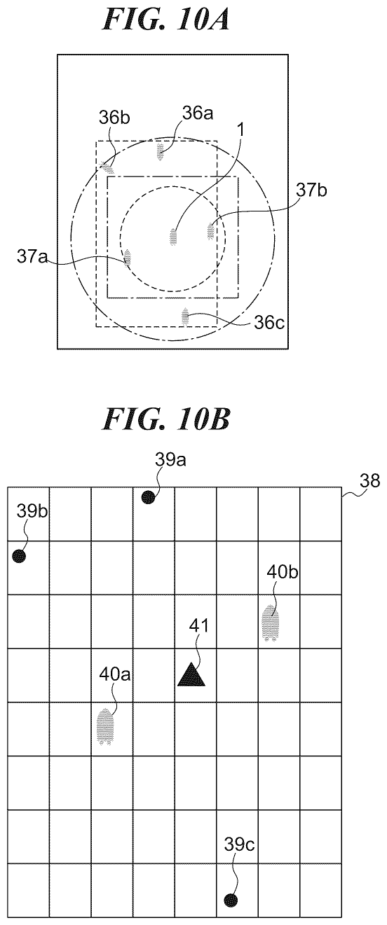

In a case where it is determined in step S61 that an obstacle is detected by the lidar 21, the process proceeds to step S63. In step S63, the BCU 16 causes the MFD 11 to display a bird's-eye view image including a display range including the obstacle detected by the radar 20, the obstacle detected by the lidar 21, and the marine vessel 1. The bird's-eye view image to be displayed in step S63 is now described with reference to FIGS. 10A and 10B.

FIG. 10A is a diagram for explaining the display range of the bird's-eye view image to be displayed in step S63. In FIG. 10A, the region indicated by a dotted circle indicates the detection range of the lidar 21, the region indicated by a dot-and-dash circle indicates the detection range of the radar 20, the region indicated by a dotted quadrangle indicates the display range of the bird's-eye view image to be displayed on the MFD 11 in step S63, and the region indicated by a dot-and-dash quadrangle indicates the display range of the reference bird's-eye view image. Here, it is assumed that a marine vessel 36a, a marine vessel 36b, and a marine vessel 36c are detected as obstacles by the radar 20, and a marine vessel 37a and a marine vessel 37b are detected not only by the radar 20 but also by the lidar 21.

In a case where the marine vessel 1, the marine vessel 36a, the marine vessel 36b, and the marine vessel 36c detected by the radar 20, and the marine vessel 37a and the marine vessel 37b detected by the lidar 21 have the positional relationship as illustrated in FIG. 10A, a bird's-eye view image 38 illustrated in FIG. 10B is displayed on the MFD 11 in step S63. The bird's-eye view image 38 includes a point 39a, a point 39b, and a point 39c respectively corresponding to the marine vessel 36a, the marine vessel 36b, and the marine vessel 36c detected by the radar 20, a region 40a and a region 40b respectively corresponding to the marine vessel 37a and the marine vessel 37b detected by the lidar 21, and a region 41 of the marine vessel 1. When the processing in step S63 is completed, this process comes to an end.

According to an example embodiment, a bird's-eye view image that has been generated based on the location data acquired by the lidar 21 and that covers a display range suitable for the state of the marine vessel 1 and/or the state around the marine vessel 1 is displayed on the MFD 11. Thus, it is possible to assist a vessel operator to easily monitor the surroundings of the marine vessel 1 in accordance with the vessel steering situation.

Also, in an example embodiment, in a case where it is determined that the marine vessel 1 is located in a slow speed zone, an enlarged bird's-eye view image obtained by enlarging the reference bird's-eye view image at a predetermined enlargement factor (e.g., at a 3× enlargement factor) is displayed on the MFD 11. Thus, it is possible to assist a vessel operator to easily monitor the vicinity of the marine vessel 1 when the marine vessel 1 is located in a slow speed zone.

Further, in an example embodiment, a determination is made as to whether the marine vessel 1 is located in a slow speed zone based on location information about the marine vessel 1 as acquired by the GPS 17. Thus, when the marine vessel 1 includes the GPS 17, it is possible to determine whether the marine vessel 1 is located in a slow speed zone, and it is possible to assist a vessel operator to easily monitor the vicinity of the marine vessel 1 when the marine vessel 1 is located in the slow speed zone.

Also, in an example embodiment, in a case where an obstacle is detected by the lidar 21, a bird's-eye view image including a display range including both the marine vessel 1 and the obstacle is displayed on the MFD 11. Thus, it is possible to assist a vessel operator to easily monitor the presence of an obstacle located around the marine vessel 1.

Further, in an example embodiment, in a case where a plurality of obstacles is detected by the lidar 21, a bird's-eye view image including a display range including the marine vessel 1 and all the obstacles is displayed on the MFD 11. Thus, in a case where a plurality of obstacles is detected by the lidar 21, it is possible to assist a vessel operator to easily monitor the presence of the plurality of obstacles located around the marine vessel 1.

In an example embodiment, in a case where it is determined that the marine vessel 1 is being steered with the joystick 10, an enlarged bird's-eye view image obtained by enlarging the reference bird's-eye view image at a predetermined enlargement factor (e.g., at a 3× enlargement factor) is displayed on the MFD 11. As a result, in a situation where the marine vessel 1 is being steered with the joystick 10, that is, in a situation where the marine vessel 1 moves at a low velocity, it is possible to display a bird's-eye view image covering the same display range as that in the case where the marine vessel 1 is located in a slow speed zone, and thus, it is possible to maintain the visibility for a vessel operator during the low-velocity movement.

In an example embodiment, in a case where it is determined that the velocity of the marine vessel 1 is a predetermined velocity (e. g., 5 km/h) or lower, an enlarged bird's-eye view image obtained by enlarging the reference bird's-eye view image at a predetermined enlargement factor (e. g., at a 3× enlargement factor) is displayed on the MFD 11. As a result, in a situation where the marine vessel 1 travels at a predetermined velocity or lower, that is, in a situation where the marine vessel 1 moves at a low velocity, it is possible to display a bird's-eye view image covering the same display range as that in the case where the marine vessel 1 is located in a slow speed zone, and thus, it is possible to maintain the visibility for a vessel operator during the low-velocity movement.

Further, in an example embodiment, as the velocity of the marine vessel 1 decreases, a greater enlargement factor is used. Thus, it is possible to assist a vessel operator to easily monitor the optimum surroundings depending on the velocity of the marine vessel 1.

In an example embodiment, in a case where it is determined that the speed of the engine 4 of the marine vessel 1 is a predetermined speed (e.g., 1200 rpm) or lower, an enlarged bird's-eye view image obtained by enlarging the reference bird's-eye view image at a predetermined enlargement factor (e. g., at a 3× enlargement factor) is displayed on the MFD 11. As a result, in a situation where the speed of the engine 4 is a predetermined speed or lower, that is, in a situation where the marine vessel 1 moves at a low velocity, it is possible to display a bird's-eye view image covering the same display range as that in the case where the marine vessel 1 is located in a slow speed zone, and thus, it is possible to maintain the visibility for a vessel operator during the low-velocity movement.

Further, in an example embodiment, as the speed of the engine 4 of the marine vessel 1 decreases, a greater enlargement factor is used. Thus, it is possible to assist a vessel operator to easily monitor the optimum surroundings depending on the speed of the engine 4.

In an example embodiment, in a case where it is determined that there is a possibility that a first obstacle detected by the radar 20 will collide with the marine vessel 1, and it is determined that a second obstacle is detected by the lidar 21 (YES in step S60 and YES in step S61), a bird's-eye view image including a display range including all the marine vessel 1, the first obstacle, and the second obstacle is displayed on the MFD 11. Thus, it is possible to assist a vessel operator to easily monitor the presence of an obstacle located in the detection range of the radar 20 having a wider detection range than the lidar 21, in addition to an obstacle located in the detection range of the lidar 21.

In an example embodiment, in a case where it is determined that there is a possibility that a first obstacle detected by the radar 20 will collide with the marine vessel 1, and it is determined that no obstacle is detected by the lidar 21 (YES in step S60 and NO in step S61), a bird's-eye view image including a display range including the marine vessel 1 and the first obstacle is displayed on the MFD 11. Thus, it is possible to assist a vessel operator to easily monitor the presence of an obstacle located outside the detection range of the lidar 21.

For example, all of the determination in step S54, the determination in step S55, and the determination in step S56 are not necessarily made in the bird's-eye view display control process, and, for example, at least one of these determinations may be made in the process.

In the above-described example embodiments, a configuration in which the lidar 21 and the radar 20 are used as the sensors to detect and acquire the location data of objects has been described. However, a sensor other than a lidar and a radar may be used in the vessel steering system 15, as long as the sensor detects and acquires the location data of an object by emitting electromagnetic waves around the marine vessel 1.

Also, in the above-described example embodiments, a configuration in which a determination is made as to whether the marine vessel 1 is located in a slow speed zone based on location information about the marine vessel 1 in step S51 has been described, but the present invention is not limited to this configuration. For example, a determination may be made as to whether the marine vessel 1 is located in a slow speed zone based on whether an automatic docking/undocking mode of the marine vessel 1 is valid. The automatic docking/undocking mode is a vessel steering mode in which the marine vessel 1 is undocked or docked by automatic vessel steering. In a case where the automatic docking/undocking mode is set to be valid by a vessel operator, it is determined that the marine vessel 1 is located in a slow speed zone. In a case where the automatic docking/undocking mode is set to be invalid by a vessel operator, it is determined that the marine vessel 1 is not located in a slow speed zone. With such control, even in a case where the GPS 17 does not function in the marine vessel 1, it is possible to determine whether the marine vessel 1 is located in a slow speed zone, and it is possible to assist a vessel operator to easily monitor the vicinity of the marine vessel 1 when the marine vessel 1 is located in the slow speed zone.

Also, in the above-described example embodiments, in a case where a plurality of obstacles is detected by the lidar 21, a bird's-eye view image including a display range including the marine vessel 1 and all the obstacles is displayed on the MFD 11. However, the present invention is not limited to this configuration. For example, the BCU 16 may determine the degrees of risk that the detected obstacles pose to the marine vessel 1, and a bird's-eye view image including a display range including the marine vessel 1 and obstacles whose degree of risk is determined to be equal to or higher than a predetermined value among the plurality of obstacles may be displayed on the MFD 11. The degree of risk described above is determined, for example, based on the distance between the detected obstacle and the marine vessel 1 or on the velocity at which the detected obstacle reaches the marine vessel 1. With such control, it is possible to assist a vessel operator to easily monitor the presence of an obstacle whose degree of risk is determined to be equal to or higher than the predetermined value.

Further, in the above-described example embodiments, a configuration in which one bird's-eye view image is displayed on the MFD 11 has been described. However, the present invention is not limited to this configuration, and, for example, a plurality of bird's-eye view images covering different display ranges may be displayed on the MFD 11.

In an example case where an obstacle is detected by the lidar 21 while the marine vessel 1 is moving at a velocity equal to or higher than a predetermined velocity, a first bird's-eye view image including a display range including both the marine vessel 1 and the obstacle, and a second bird's-eye view image including a display range centered on the obstacle may be displayed on the MFD 11. With such control, when the marine vessel 1 is moving at a velocity equal to or higher than the predetermined velocity, it is possible to assist a vessel operator to easily monitor the presence of an obstacle located around the marine vessel 1 and the surroundings of the obstacle at the same time.

In another example case where it is determined that the marine vessel 1 is located in a slow speed zone, and an obstacle is detected by the lidar 21, a bird's-eye view image including a display range including both the marine vessel 1 and the obstacle, and an enlarged bird's-eye view image obtained by enlarging the reference bird's-eye view image at a predetermined enlargement factor (e.g., at a 3× enlargement factor) may be displayed on the MFD 11. With such control, when the marine vessel 1 is located in a slow speed zone, it is possible to assist a vessel operator to easily monitor the presence of an obstacle located around the marine vessel 1 and the vicinity of the marine vessel 1 at the same time.

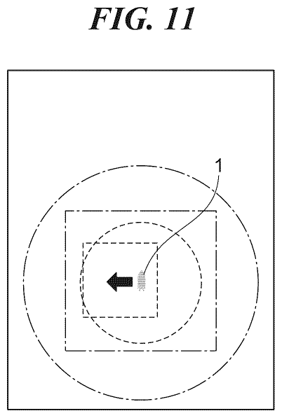

Also, in the above-described example embodiments, a configuration in which the enlarged bird's-eye view image obtained by enlarging the reference bird's-eye view image at a predetermined enlargement factor (e.g., at a 3× enlargement factor) is displayed on the MFD 11 in step S52 has been described, but the present invention is not limited to this configuration. For example, an enlarged bird's-eye view image that is obtained by enlarging the reference bird's-eye view image at a predetermined enlargement factor (e.g., at a 3× enlargement factor), and is obtained by shifting the center position of the display range from the marine vessel 1 in the moving direction of the marine vessel 1 may be displayed on the MFD 11. For example, an enlarged bird's-eye view image covering the display range indicated by a dotted quadrangle in FIG. 11 is displayed on the MFD 11, and the center position of the display range is shifted from the marine vessel 1 in the moving direction of the marine vessel 1 (the direction indicated by the arrow in FIG. 11). With such control, it is possible to cause the MFD 11 to display a bird's-eye view image that takes the movement of the marine vessel 1 into consideration in an undocking operation or a docking operation, and it is possible to assist a vessel operator to easily monitor the vicinity of the marine vessel 1.

Further, in the above-described example embodiments, a configuration in which a bird's-eye view image is displayed on the MFD 11 of the marine vessel 1 has been described, but the present invention is not limited to this configuration. For example, a bird's-eye view image may be displayed on a display of a remote vessel steering system for remotely steering the marine vessel 1 from the land. Thus, it is possible to assist a vessel operator remotely operating the marine vessel 1 to easily monitor the surroundings of the marine vessel 1 in accordance with the vessel steering situation.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image display system for a marine vessel, the image display system comprising:
a display;
a sensor to detect and acquire location data of an object by emitting electromagnetic waves around the marine vessel; and
a controller configured or programmed to cause the display to display a bird's-eye view image of the marine vessel that is generated based on the location data; wherein
the controller is configured or programmed to control the display to display the bird's-eye view image including a display range differentiated based on at least one of a state of the marine vessel or a state around the marine vessel.

2. The image display system according to claim 1, wherein
the controller is configured or programmed to determine whether the marine vessel is located in a predetermined slow speed zone; and
in a case where it is determined that the marine vessel is located in the predetermined slow speed zone, the controller is configured or programmed to cause the display to display an enlarged bird's-eye view image obtained by enlarging at a predetermined enlargement factor a reference bird's-eye view image including a display range centered on the marine vessel.

3. The image display system according to claim 2, wherein the controller is configured or programmed to determine whether the marine vessel is located in the predetermined slow speed zone based on location information about the marine vessel.

4. The image display system according to claim 2, wherein the controller is configured or programmed to determine whether the marine vessel is located in the predetermined slow speed zone based on information about a vessel steering mode that is set by a vessel operator of the marine vessel.

5. The image display system according to claim 1, wherein in a case where an obstacle is detected based on the location data, the controller is configured or programmed to cause the display to display the bird's-eye view image including a display range including the marine vessel and the obstacle.

6. The image display system according to claim 5, wherein in a case where a plurality of obstacles are detected based on the location data, the controller is configured or programmed to cause the display to display the bird's-eye view image including a display range including the marine vessel and the plurality of obstacles.

7. The image display system according to claim 5, wherein
the controller is configured or programmed to determine a degree of risk to the marine vessel by the obstacle detected based on the location data; and
in a case where a plurality of obstacles are detected based on the location data, the controller is configured or programmed to cause the display to display the bird's-eye view image including a display range including the marine vessel and an obstacle with a degree of risk equal to or higher than a predetermined value among the plurality of obstacles.

8. The image display system according to claim 1, wherein
the controller is configured or programmed to determine whether the marine vessel is being steered with a specific operating mechanism; and
in a case where it is determined that the marine vessel is being steered with the specific operating mechanism, the controller is configured or programmed to cause the display to display an enlarged bird's-eye view image obtained by enlarging at a predetermined enlargement factor a reference bird's-eye view image including a display range centered on the marine vessel.

9. The image display system according to claim 1, wherein
the controller is configured or programmed to determine whether a velocity of the marine vessel is equal to or lower than a predetermined velocity; and
in a case where it is determined that the velocity of the marine vessel is equal to or lower than the predetermined velocity, the controller is configured or programmed to cause the display to display an enlarged bird's-eye view image obtained by enlarging at a predetermined enlargement factor a reference bird's-eye view image including a display range centered on the marine vessel.

10. The image display system according to claim 9, wherein the controller is configured or programmed to increase the predetermined enlargement factor as the velocity of the marine vessel decreases.

11. The image display system according to claim 1, wherein
the controller is configured or programmed to determine whether a speed of an engine of the marine vessel is equal to or lower than a predetermined speed; and
in a case where it is determined that the speed of the engine of the marine vessel is equal to or lower than the predetermined speed, the controller is configured or programmed to cause the display to display an enlarged bird's-eye view image obtained by enlarging at a predetermined enlargement factor a reference bird's-eye view image including a display range centered on the marine vessel.

12. The image display system according to claim 11, wherein the controller is configured or programmed to increase the predetermined enlargement factor as the speed of the engine of the marine vessel decreases.

13. The image display system according to claim 1, wherein
the controller is configured or programmed to make:
a first determination as to whether the marine vessel is located in a predetermined slow speed zone; and
at least one of a second determination as to whether the marine vessel is being steered with a specific operating mechanism, a third determination as to whether a velocity of the marine vessel is equal to or lower than a predetermined velocity, or a fourth determination as to whether a speed of an engine of the marine vessel is equal to or lower than a predetermined speed; and
the controller is configured or programmed to cause the display to display the bird's-eye view image including a display range differentiated based on results of the made determinations.

14. The image display system according to claim 1, further comprising:
another sensor to detect and acquire location data of an object by emitting electromagnetic waves around the marine vessel, the another sensor having a wider detection range than the sensor; wherein
the controller is configured or programmed to determine whether there is a possibility that a first obstacle detected based on the location data acquired by the another sensor will collide with the marine vessel, and further determine whether a second obstacle is detected based on the location data acquired by the sensor; and
in a case where it is determined that there is a possibility that the first obstacle will collide with the marine vessel, and it is determined that the second obstacle is detected based on the location data acquired by the sensor, the controller is configured or programmed to cause the display to display the bird's-eye view image including a display range including the marine vessel, the first obstacle, and the second obstacle.

15. The image display system according to claim 14, wherein in a case where it is determined that there is a possibility that the first obstacle will collide with the marine vessel, and it is determined that the second obstacle is not detected based on the location data acquired by the sensor, the controller is configured or programmed to cause the display to display the bird's-eye view image including a display range including the marine vessel and the first obstacle.

16. The image display system according to claim 1, wherein the controller is configured or programmed to cause the display to display a plurality of the bird's-eye view images covering different display ranges.

17. The image display system according to claim 16, wherein in a case where an obstacle is detected based on the location data while the marine vessel is moving at a velocity equal to or higher than a predetermined velocity, the controller is configured or programmed to cause the display to display a first bird's-eye view image including a display range including the marine vessel and the obstacle, and a second bird's-eye view image including a display range centered on the obstacle.

18. The image display system according to claim 16, wherein
the controller is configured or programmed to determine whether the marine vessel is located in a predetermined slow speed zone; and
in a case where it is determined that the marine vessel is located in the predetermined slow speed zone, and an obstacle is detected based on the location data, the controller is configured or programmed to cause the display to display the bird's-eye view image including a display range including the marine vessel and the obstacle, and an enlarged bird's-eye view image obtained by enlarging at a predetermined enlargement factor a reference bird's-eye view image including a display range centered on the marine vessel.

19. The image display system according to claim 1, wherein when the marine vessel performs an undocking operation or a docking operation, the controller is configured or programmed to cause the display to display an enlarged bird's-eye view image that is obtained by enlarging at a predetermined enlargement factor a reference bird's-eye view image including a display range centered on the marine vessel, and that is obtained by shifting a center position of the display range from the marine vessel in a moving direction of the marine vessel.

20. An image display method for a marine vessel, the method comprising:
detecting and acquiring location data of an object by emitting electromagnetic waves around the marine vessel; and
causing a display to display a bird's-eye view image of the marine vessel that is generated based on the location data; wherein
in displaying the bird's-eye view image, the display is controlled to display the bird's-eye view image including a display range differentiated based on at least one of a state of the marine vessel or a state around the marine vessel.
